(19) United States
(12) Patent Application Publication
(10) Pub. No.: US 2019/0166401 A1
(43) Pub. Date: May 30, 2019

(54) DIGITAL MEDIA COMBINER

(71) Applicants: Tariq Ahmad, Reno, NV (US); Christopher Sietsema, Reno, NV (US); Rene Ernesto Corcios, Elko, NV (US)

(72) Inventors: Tariq Ahmad, Reno, NV (US); Christopher Sietsema, Reno, NV (US); Rene Ernesto Corcios, Elko, NV (US)

(73) Assignee: Reno Technologies Inc, Reno, NV (US)

(21) Appl. No.: 15/827,933

(22) Filed: Nov. 30, 2017

(51) Int. Cl. H04N 21/462; H04H 60/09; H04N 21/482; H04N 5/44

(52) U.S. Cl. CPC H04N 21/4622; H04H 60/09; H04N 2005/44565; H04N 5/4401; H04H 2201/40; H04N 21/482

(57) ABSTRACT

Methods, systems, and devices for combining an over-the-air broadcast signal with another digital media signal are described. Broadcast signals may be received at a user's location, demodulated, and then remodulated using the modulation scheme of a non-broadcast signal. The remodulated broadcast signal may then be combined with the non-broadcast signal, and the combined signal may be transmitted to a user's video equipment. In some cases, a channel guide interface may be provided that includes both the broadcast and non-broadcast media channels.

### BACKGROUND

The following relates generally to combining digital signals, and more specifically to combining an over-the-air broadcast signal with another digital media signal.

Video content may be received from over-the-air broadcast sources or from non-broadcast sources such as cable and satellite. In some cases, a user may receive broadcast content directly. In other cases, a content provider such as a cable television operator (CTO) may retransmit broadcast signals to a user.

In some cases, broadcast channels may be received over the air at the user's location and fed into a television using a first input (e.g., through the radio frequency (RF) input), while non-broadcast cable channels may be fed into the television using a separate input. The user may select broadcast or non-broadcast signals by physically changing the input selection on the television. However, this process may be confusing, inconvenient, and inefficient for the user.

### SUMMARY

Broadcast signals may be received at a user's location, demodulated, and then remodulated using the modulation scheme of a non-broadcast signal. The remodulated broadcast signal may then be combined with the non-broadcast signal, and the combined signal may be transmitted to a user's video equipment. In some cases, a channel guide interface may be provided that includes both the broadcast and non-broadcast media channels. In some cases, the non-broadcast signal, channel guide interface, or both may include empty channels as placeholders for the broadcast channels.

In one embodiment, a method may include receiving a first media signal, where the first media signal comprises a wireless radio transmission, demodulating the first media signal according to a first modulation scheme, modulating the demodulated first media signal according to a second modulation scheme different from the first modulation scheme, combining the first media signal with a second media signal to generate a combined signal, where the second media signal is modulated according to the second modulation scheme, and transmitting the combined signal to the video equipment.

In one embodiment, a non-transitory computer-readable medium may include instructions operable to cause a processor to receive a first media signal, where the first media signal comprises a wireless radio transmission, demodulate the first media signal according to a first modulation scheme, modulate the demodulated first media signal according to a second modulation scheme different from the first modulation scheme, combine the first media signal with a second media signal to generate a combined signal, where the second media signal is modulated according to the second modulation scheme, and transmit the combined signal to the video equipment.

In one embodiment, an apparatus may include a processor, memory in electronic communication with the processor, and instructions stored in the memory. The instructions may be operable to cause the processor to receive a first media signal, where the first media signal comprises a wireless radio transmission, demodulate the first media signal according to a first modulation scheme, modulate the demodulated first media signal according to a second modulation scheme different from the first modulation scheme, combine the first media signal with a second media signal to generate a combined signal, where the second media signal is modulated according to the second modulation scheme, and transmit the combined signal to the video equipment.

In one embodiment, an apparatus may include means for receiving a first media signal, where the first media signal comprises a wireless radio transmission, means for demodulating the first media signal according to a first modulation scheme, means for modulating the demodulated first media signal according to a second modulation scheme different from the first modulation scheme, means for combining the first media signal with a second media signal to generate a combined signal, where the second media signal is modulated according to the second modulation scheme, and means for transmitting the combined signal to the video equipment.

Some examples of the method, non-transitory computer-readable medium, and apparatus described above may further include processes, features, means, or instructions for identifying one or more unused frequency channels that may be not occupied by the second media signal. In some cases, combining the first media signal and the second media signal comprises: inserting the first media signal into the one or more unused frequency channels.

Some examples of the method, non-transitory computer-readable medium, and apparatus described above may further include processes, features, means, or instructions for receiving the combined signal. Some examples of the method, non-transitory computer-readable medium, and apparatus described above may further include processes, features, means, or instructions for identifying at least one media channel from the first media signal and a set of media channels from the second media signal.

Some examples of the method, non-transitory computer-readable medium, and apparatus described above may further include processes, features, means, or instructions for identifying a set of channel numbers corresponding to the set of media channels from the second media signal. Some examples of the method, non-transitory computer-readable medium, and apparatus described above may further include processes, features, means, or instructions for identifying at least one unused channel number that may be not in the set of channel numbers.

Some examples of the method, non-transitory computer-readable medium, and apparatus described above may further include processes, features, means, or instructions for generating a channel guide user interface, where the channel guide interface comprises a reference for each of the set of channel numbers to the corresponding media channels from the set of media channels from the second media signal and a reference for the at least one unused channel number to the at least one media channel from the first media signal. Some examples of the method, non-transitory computer-readable medium, and apparatus described above may further include processes, features, means, or instructions for transmitting the channel guide user interface to the video equipment.

In some examples of the method, non-transitory computer-readable medium, and apparatus described above, the first modulation scheme comprises an 8-level vestigial sideband modulation (8VSB) modulation scheme. In some examples, the second modulation scheme comprises a quadrature amplitude modulation (QAM) or IP modulation scheme. In some examples of the method, non-transitory computer-readable medium, and apparatus described above, the first media signal comprises an unencrypted media signal. In some examples of the method, non-transitory computer-readable medium, and apparatus described above, the second media signal comprises an encrypted media signal.

In some examples of the method, non-transitory computer-readable medium, and apparatus described above, the first media signal and the second media signal each comprise digital video signals. In some examples of the method, non-transitory computer-readable medium, and apparatus described above, the first media signal comprises an over-the-air broadcast signal. In some examples of the method, non-transitory computer-readable medium, and apparatus described above, the second media signal comprises a cable television signal, a satellite television signal, a streaming media signal, or any combination thereof.

### BRIEF DESCRIPTION OF THE DRAWINGS

FIG. 1 shows a diagram of a signal combination system that supports combining an over-the-air broadcast signal with another digital media signal in accordance with aspects of the present disclosure.

FIG. 2 shows a diagram of a digital media combiner that supports combining an over-the-air broadcast signal with another digital media signal in accordance with aspects of the present disclosure.

FIG. 3 shows a flowchart of a process performed by a signal combination system for combining an over-the-air broadcast signal with another digital media signal in accordance with aspects of the present disclosure.

FIGS. 4 through 5 show flowcharts of processes performed by a digital media combiner for combining an over-the-air broadcast signal with another digital media signal in accordance with aspects of the present disclosure.

### DETAILED DESCRIPTION

Government regulations may prohibit cable operators and other multichannel video programming distributors (MVPDs) from retransmitting commercial television, low power television and radio broadcast signals without first obtaining the broadcaster's consent. This permission may be known as “retransmission consent” and may involve compensation from the cable company to the broadcaster for the use of the signal. Alternately, local commercial and noncommercial television broadcast stations may require a cable operator that serves the same market as the broadcaster to carry its signal. A demand for carriage may be known as “must-carry.”

If the broadcast station asserts its must-carry rights, it may not demand compensation from the cable operator. In some cases, regulations may require cable operators to set aside a specified portion of their channels for local commercial and non-commercial television stations. Local television stations choosing the must-carry option and those that have negotiated agreements for retransmission with the cable system may count towards this quota. Local commercial television stations have the option of electing must-carry status or retransmission consent status, while local noncommercial television stations may only seek carriage on a must-carry basis. In some cases, must-carry stations may be guaranteed carriage on a preferred channel number. For example, commercial stations that have elected must-carry status have the option of requesting carriage on the same channel number that they occupy over-the-air or on any channel that is mutually agreed upon by the station and the cable operator.

In some cases, legal restrictions may allow broadcast channels to be received freely at the user's location, but may prohibit these signals from being received at a third party central location and retransmitted to the end user without the consent of the broadcast channel operator. Thus, according to the present disclosure, broadcast signals may be received at a user's location and combined with a non-broadcast signal on location.

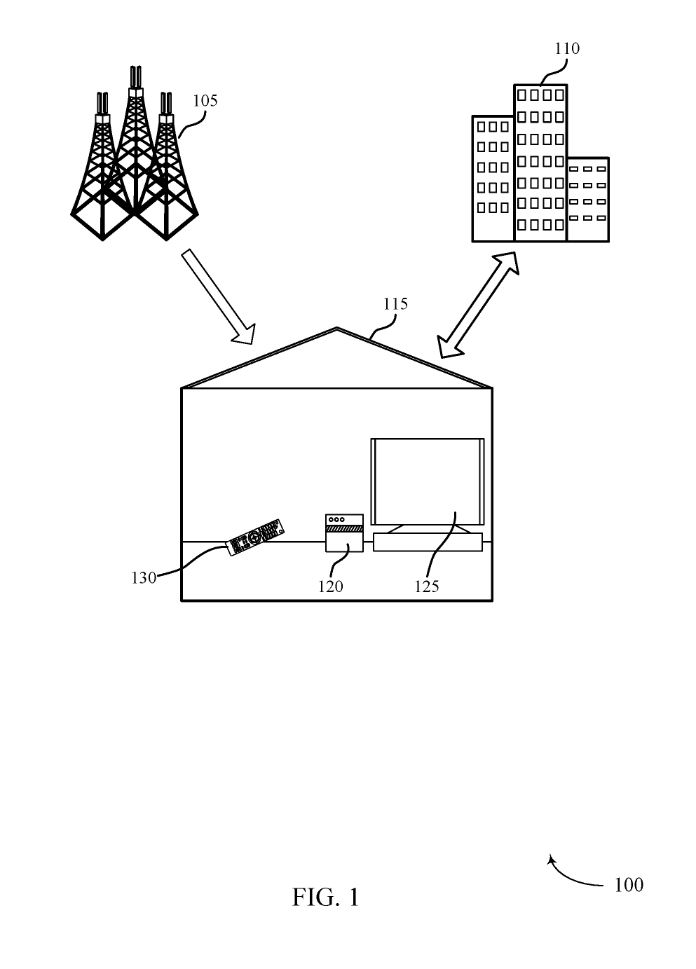

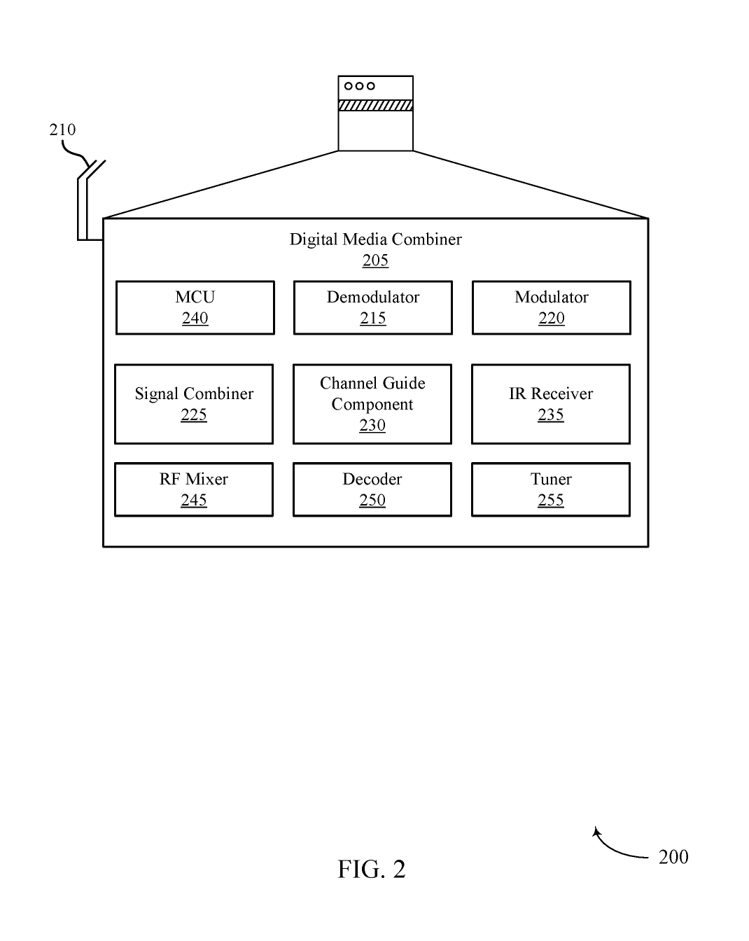

FIG. 1 shows a diagram 100 of a signal combination system that supports combining an over-the-air broadcast signal with another digital media signal in accordance with aspects of the present disclosure. Diagram 100 may include broadcaster 105, cable plant 110, user location 115, digital media combiner 120, video equipment 125, and remote control 130. Digital media combiner 120 may incorporate aspects of digital media combiner 205 as described with reference to FIG. 2.

The digital media combiner 120 may receive a local over-the-air broadcast signal (which may be modulated using the 8VSB modulation) at a user's location 115 by means of a receiver antenna, and convert the signals to unencrypted QAM signals. The unencrypted QAM signals may be combined using RF, composite video, or HDMI outputs with the encrypted QAM signals from a CTO or from a streaming digital video signal. The combined QAM output signals may be inserted into the user's audio or video equipment (e.g., a television, tablet, radio, or other media display device). This may provide the user with a seamless video viewing experience, and may still utilize an interactive channel guide from the CTO.

The broadcaster 105 outputs over-the-air video signals. The broadcaster 105 may output video signals in the form of 8VSB signals, National Television System Committee (NTSC) signals, or any other suitable broadcast media signal. Multiple broadcasters 105 may provide service the user location 115, and each service may be associated with a different channel. A channel may refer to a number or other designator that may enable a user to identify and select a media service (i.e., from a channel selector on a television, an interactive media guide, or a remote control). In some cases, multiple channels may be provided by a single broadcaster 105.

The cable plant 110 represents the infrastructure of a CTO or other MVPD, and may output non-broadcast video signals. The cable plant 110 represents an example of a non-broadcast media provider, but other examples are possible, including streaming digital media providers. The output of the cable plant 110 signal may be carried over wire infrastructure, satellite, or the internet. The wire infrastructure may be referred to as the cable service, or simply “cable”. In some cases, non-broadcast video signals may not be publically accessible without a prior agreement to the provider.

The user location 115 may be a residence or a commercial location where a user may view audio or video content. The digital media combiner 120 receives video signals from a multitude of sources and outputs a single video signal to the video equipment 125. The term video equipment may also be used to refer to audio equipment or other devices that display media or facilitate media consumption. The video equipment 125 receives a video signal from the digital media combiner 120 and displays content to the user. The remote control 130 allows the user to operate the video equipment 125 and the channel guide.

FIG. 2 shows a diagram 200 of a digital media combiner 205 that supports combining an over-the-air broadcast signal with another digital media signal in accordance with aspects of the present disclosure. In some examples, digital media combiner 205 may include antenna 210, demodulator 215, modulator 220, signal combiner 225, channel guide component 230, IR receiver 235, MCU 240, radio frequency (RF) mixer 245, decoder 250, and tuner 255. In some embodiments, the components of the digital media combiner 205 may be combined in a single device, or they may be distributed across two or more separate devices that together may accomplish the functions described herein.

Digital media combiner 205 may incorporate aspects of digital media combiner 120 as described with reference to FIG. 1. Antenna 210 may receive a first media signal, where the first media signal comprises a wireless radio transmission. In some cases, the first media signal comprises an over-the-air broadcast signal.

Demodulator 215 may demodulate the first media signal according to a first modulation scheme. Modulator 220 may modulate the demodulated first media signal according to a second modulation scheme different from the first modulation scheme.

Signal combiner 225 may combine the first media signal with a second media signal to generate a combined signal (where the second media signal is modulated according to the second modulation scheme); transmit the combined signal to the video equipment; identify one or more unused frequency channels that are not occupied by the second media signal; and combine the first media signal and the second media signal by inserting the first media signal into the one or more unused frequency channels.

In some cases, the first modulation scheme comprises an 8VSB modulation scheme. In some cases, the second modulation scheme comprises a QAM modulation scheme or an IP packet scheme. In some cases, the first media signal comprises an unencrypted media signal. In some cases, the second media signal comprises an encrypted media signal. In some cases, the first media signal and the second media signal each comprise digital video signals. In some cases, the second media signal comprises a cable television signal, a satellite television signal, a streaming media signal, or any combination thereof.

Channel guide component 230 may receive the combined signal; identify at least one media channel from the first media signal and a set of media channels from the second media signal; identify a set of channel numbers corresponding to the set of media channels from the second media signal; identify at least one unused channel number that is not in the set of channel numbers; generate a channel guide user interface, where the channel guide interface comprises a reference for each of the set of channel numbers to the corresponding media channels from the set of media channels from the second media signal and a reference for the at least one unused channel number to the at least one media channel from the first media signal; and transmit the channel guide user interface to the video equipment.

The digital media combiner 205 may allow the CTO or video streaming service to avoid retransmitting local over-the-air broadcast channels through the cable plant, therefore dropping the requirement for the CTO to have a retransmission consent agreement. In some cases, the CTO may leave the frequency empty for insertion of the local over-the-air broadcast channels. Thus, the CTO-provided interface for an interactive channel guide may work seamlessly with the inserted local over-the-air broadcast channels.

The antenna 210 receives signals from over-the-air broadcasts. The tuner 255 tunes the receiver to receive the 8VSB signals or Advanced Television Systems Committee (ATSC) signals. The demodulator 215 takes the ATSC signals and converts them into digital or analog signals. The modulator 220 takes generated digital or analog signals and transforms them into unencrypted QAM signals. The signal combiner 225 combines the broadcast and non-broadcast signals once the broadcast signals are converted to the same modulation scheme as the non-broadcast signals.

In general, modulation is the process of representing a digital signal by modifying the properties of a periodic waveform (e.g., frequency, amplitude and phase). Demodulation takes a modified waveform and generates a digital signal. A modulated waveform may be divided into time units known as symbols. Each symbol may be modulated separately. In a wireless communication system that uses narrow frequency subcarriers to transmit distinct symbols, the modulation is accomplished by varying the phase and amplitude of each symbol. For example, a binary phase shift keying (BPSK) modulation scheme conveys information by alternating between waveforms that are transmitted with no phase offset or with a 180° offset (i.e., each symbol conveys a single bit of information).

In a QAM scheme, two carrier signals (known as the in-phase component, I, and the quadrature component, Q) may be transmitted with a phase offset of 90°, and each signal may be transmitted with specific amplitude selected from a finite set. The number of amplitude bins determines the number of bits that are conveyed by each symbol. For example, in a 16 QAM scheme, each carrier signal may have one of four amplitudes (e.g., −3, −1, 1, 3), which results in 16 possible combinations (i.e., 4 bits). The various possible combinations may be represented in a graph known as a constellation map, where the amplitude of the I component is represented on the horizontal axis and the Q component is represented on the vertical axis.

MVPDs such as CTOs may receive local off-air broadcast signals which may be transmitted over-the-air under the ATSC standard. ATSC standards for local off air broadcast signals may include 8VSB, which is in a digital format. The CTO may then convert the signals to either Analog (RF) or QAM, and transmits these signals through the cable plant to their users.

In some cases, an MVPD may compress and encrypt the signals via QAM modulation prior to reception by the user. The signal may then be decoded using equipment at the user's location (which may consist of Digital Video Recorder (DVR), Set Top Box, or other video provider equipment). In some cases, the DVR or Set Top Box, or other suitable video provider equipment may be collocated with the digital media combiner 205 in a single device. In other cases, they may be two separate devices.

The RF mixer 245 takes unencrypted QAM signals, designates and channel maps them into new unencrypted QAM signals to be compatible with the video provider equipment. The IR receiver 235 receives signals from the remote control for channel selection. The MCU 240 performs various special purpose and general purpose processing tasks. The decoder 250 takes decodes a demodulated signal. In some cases, the decoder may associated channels to the channel designators.

The channel guide component 230 generates an interface that provides a channel map of the video content. It contains channels with content from both broadcast and non-broadcast sources. The channel guide component 230 may be interactive and respond to user input provided through the remote control or other user input components.

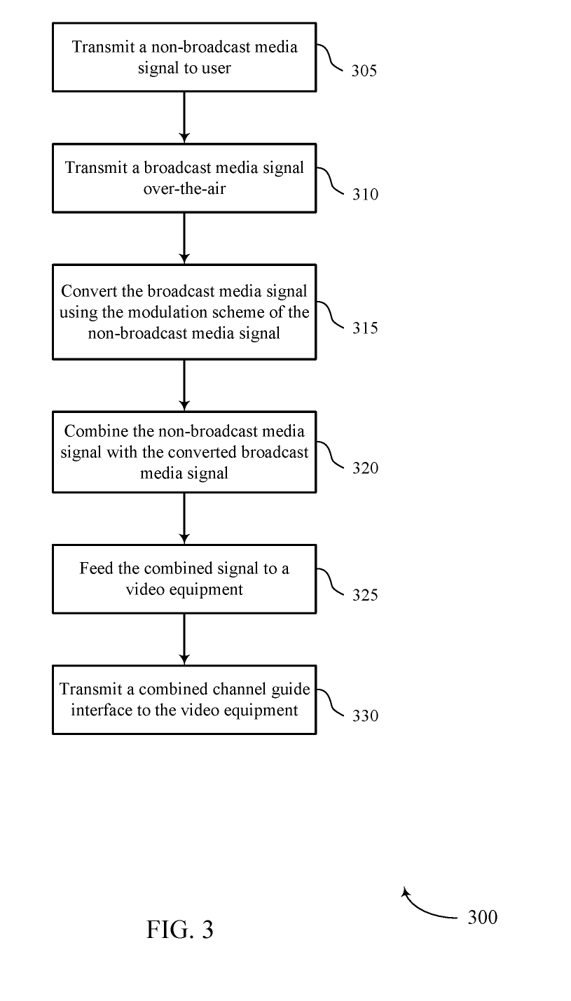

FIG. 3 shows a flowchart 300 of a process performed by a signal combination system for combining an over-the-air broadcast signal with another digital media signal in accordance with aspects of the present disclosure. In some examples, a signal combination system may execute a set of codes to control functional elements of the signal combination system to perform the described functions. Additionally or alternatively, a signal combination system may use special-purpose hardware.

At block 305 the cable plant may transmit a non-broadcast media signal to user. These operations may be performed according to the methods and processes described in accordance with aspects of the present disclosure. For example, the operations may be composed of various substeps, or may be performed in conjunction with other operations described herein. In certain examples, aspects of the described operations may be performed by a cable plant 110 as described with reference to FIG. 1.

At block 310 the broadcaster may transmit a broadcast media signal over-the-air. These operations may be performed according to the methods and processes described in accordance with aspects of the present disclosure. For example, the operations may be composed of various substeps, or may be performed in conjunction with other operations described herein. In certain examples, aspects of the described operations may be performed by a broadcaster 105 as described with reference to FIG. 1.

At block 315 the digital media combiner may convert the broadcast media signal using the modulation scheme of the non-broadcast media signal. These operations may be performed according to the methods and processes described in accordance with aspects of the present disclosure. For example, the operations may be composed of various substeps, or may be performed in conjunction with other operations described herein. In certain examples, aspects of the described operations may be performed by a digital media combiner 120 and 205 as described with reference to FIGS. 1 and 2.

At block 320 the digital media combiner may combine the non-broadcast media signal with the converted broadcast media signal. These operations may be performed according to the methods and processes described in accordance with aspects of the present disclosure. For example, the operations may be composed of various substeps, or may be performed in conjunction with other operations described herein. In certain examples, aspects of the described operations may be performed by a digital media combiner 120 and 205 as described with reference to FIGS. 1 and 2.

At block 325 the digital media combiner may feed the combined signal to a video equipment. These operations may be performed according to the methods and processes described in accordance with aspects of the present disclosure. For example, the operations may be composed of various substeps, or may be performed in conjunction with other operations described herein. In certain examples, aspects of the described operations may be performed by a digital media combiner 120 and 205 as described with reference to FIGS. 1 and 2.

At block 330 the digital media combiner may transmit a combined channel guide interface to the video equipment. These operations may be performed according to the methods and processes described in accordance with aspects of the present disclosure. For example, the operations may be composed of various substeps, or may be performed in conjunction with other operations described herein. In certain examples, aspects of the described operations may be performed by a digital media combiner 120 and 205 as described with reference to FIGS. 1 and 2.

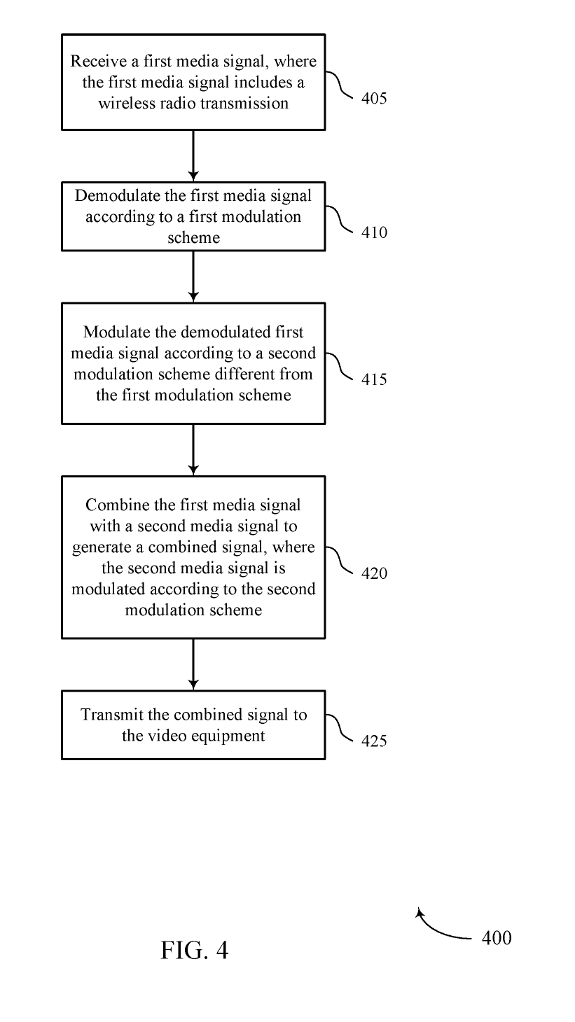

FIG. 4 shows a flowchart 400 of a process performed by a digital media combiner for combining an over-the-air broadcast signal with another digital media signal in accordance with aspects of the present disclosure. In some examples, a digital media combiner may execute a set of codes to control functional elements of the digital media combiner to perform the described functions. Additionally or alternatively, a digital media combiner may use special-purpose hardware.

At block 405 the digital media combiner may receive a first media signal, where the first media signal comprises a wireless radio transmission. These operations may be performed according to the methods and processes described in accordance with aspects of the present disclosure. For example, the operations may be composed of various substeps, or may be performed in conjunction with other operations described herein. In certain examples, aspects of the described operations may be performed by an antenna 210 as described with reference to FIG. 2.

At block 410 the digital media combiner may demodulate the first media signal according to a first modulation scheme. These operations may be performed according to the methods and processes described in accordance with aspects of the present disclosure. For example, the operations may be composed of various substeps, or may be performed in conjunction with other operations described herein. In certain examples, aspects of the described operations may be performed by a demodulator 215 as described with reference to FIG. 2.

At block 415 the digital media combiner may modulate the demodulated first media signal according to a second modulation scheme different from the first modulation scheme. These operations may be performed according to the methods and processes described in accordance with aspects of the present disclosure. For example, the operations may be composed of various substeps, or may be performed in conjunction with other operations described herein. In certain examples, aspects of the described operations may be performed by a modulator 220 as described with reference to FIG. 2.

At block 420 the digital media combiner may combine the first media signal with a second media signal to generate a combined signal, where the second media signal is modulated according to the second modulation scheme. These operations may be performed according to the methods and processes described in accordance with aspects of the present disclosure. For example, the operations may be composed of various substeps, or may be performed in conjunction with other operations described herein. In certain examples, aspects of the described operations may be performed by a signal combiner 225 as described with reference to FIG. 2.

At block 425 the digital media combiner may transmit the combined signal to the video equipment. These operations may be performed according to the methods and processes described in accordance with aspects of the present disclosure. For example, the operations may be composed of various substeps, or may be performed in conjunction with other operations described herein. In certain examples, aspects of the described operations may be performed by a signal combiner 225 as described with reference to FIG. 2.

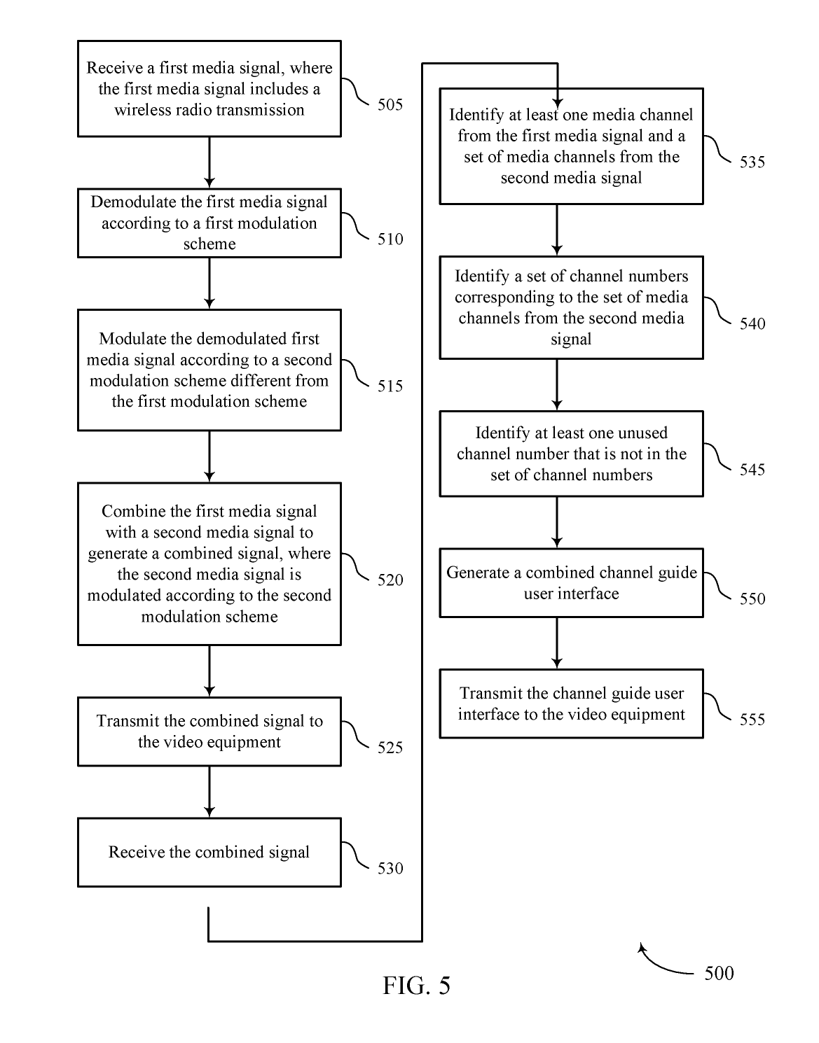

FIG. 5 shows a flowchart 500 of a process performed by a digital media combiner for combining an over-the-air broadcast signal with another digital media signal in accordance with aspects of the present disclosure. In some examples, a digital media combiner may execute a set of codes to control functional elements of the digital media combiner to perform the described functions. Additionally or alternatively, a digital media combiner may use special-purpose hardware.

At block 505 the digital media combiner may receive a first media signal, where the first media signal comprises a wireless radio transmission. These operations may be performed according to the methods and processes described in accordance with aspects of the present disclosure. For example, the operations may be composed of various substeps, or may be performed in conjunction with other operations described herein. In certain examples, aspects of the described operations may be performed by an antenna 210 as described with reference to FIG. 2.

At block 510 the digital media combiner may demodulate the first media signal according to a first modulation scheme. These operations may be performed according to the methods and processes described in accordance with aspects of the present disclosure. For example, the operations may be composed of various substeps, or may be performed in conjunction with other operations described herein. In certain examples, aspects of the described operations may be performed by a demodulator 215 as described with reference to FIG. 2.

At block 515 the digital media combiner may modulate the demodulated first media signal according to a second modulation scheme different from the first modulation scheme. These operations may be performed according to the methods and processes described in accordance with aspects of the present disclosure. For example, the operations may be composed of various substeps, or may be performed in conjunction with other operations described herein. In certain examples, aspects of the described operations may be performed by a modulator 220 as described with reference to FIG. 2.

At block 520 the digital media combiner may combine the first media signal with a second media signal to generate a combined signal, where the second media signal is modulated according to the second modulation scheme. These operations may be performed according to the methods and processes described in accordance with aspects of the present disclosure. For example, the operations may be composed of various substeps, or may be performed in conjunction with other operations described herein. In certain examples, aspects of the described operations may be performed by a signal combiner 225 as described with reference to FIG. 2.

At block 525 the digital media combiner may transmit the combined signal to the video equipment. These operations may be performed according to the methods and processes described in accordance with aspects of the present disclosure. For example, the operations may be composed of various substeps, or may be performed in conjunction with other operations described herein. In certain examples, aspects of the described operations may be performed by a signal combiner 225 as described with reference to FIG. 2.

At block 530 the digital media combiner may receive the combined signal. These operations may be performed according to the methods and processes described in accordance with aspects of the present disclosure. For example, the operations may be composed of various substeps, or may be performed in conjunction with other operations described herein. In certain examples, aspects of the described operations may be performed by a channel guide component 230 as described with reference to FIG. 2.

At block 535 the digital media combiner may identify at least one media channel from the first media signal and a set of media channels from the second media signal. These operations may be performed according to the methods and processes described in accordance with aspects of the present disclosure. For example, the operations may be composed of various substeps, or may be performed in conjunction with other operations described herein. In certain examples, aspects of the described operations may be performed by a channel guide component 230 as described with reference to FIG. 2.

At block 540 the digital media combiner may identify a set of channel numbers corresponding to the set of media channels from the second media signal. These operations may be performed according to the methods and processes described in accordance with aspects of the present disclosure. For example, the operations may be composed of various substeps, or may be performed in conjunction with other operations described herein. In certain examples, aspects of the described operations may be performed by a channel guide component 230 as described with reference to FIG. 2.

At block 545 the digital media combiner may identify at least one unused channel number that is not in the set of channel numbers. These operations may be performed according to the methods and processes described in accordance with aspects of the present disclosure. For example, the operations may be composed of various substeps, or may be performed in conjunction with other operations described herein. In certain examples, aspects of the described operations may be performed by a channel guide component 230 as described with reference to FIG. 2.

At block 550 the digital media combiner may generate a combined channel guide user interface. These operations may be performed according to the methods and processes described in accordance with aspects of the present disclosure. For example, the operations may be composed of various substeps, or may be performed in conjunction with other operations described herein. In certain examples, aspects of the described operations may be performed by a channel guide component 230 as described with reference to FIG. 2.

At block 555 the digital media combiner may transmit the channel guide user interface to the video equipment. These operations may be performed according to the methods and processes described in accordance with aspects of the present disclosure. For example, the operations may be composed of various substeps, or may be performed in conjunction with other operations described herein. In certain examples, aspects of the described operations may be performed by a channel guide component 230 as described with reference to FIG. 2.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application-specific integrated circuit (ASIC), a field-programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read only memory (ROM), electrically erasable programmable read only memory (EEPROM), compact disk (CD) ROM or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, digital subscriber line (DSL), or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.”

1. A method for combining digital signals, comprising:
receiving a first media signal at a user location, wherein the first media signal comprises a wireless radio transmission using a first modulation scheme;
receiving a second media signal at the user location, wherein the second media signal is transmitted from a remote location using a second modulation scheme different from the first modulation scheme;
demodulating the first media signal according to the first modulation scheme;
modulating the demodulated first media signal according to the second modulation scheme;
combining, at the user location, the first media signal with a second media signal to generate a combined signal, wherein the combined media signal is modulated according to the second modulation scheme, and wherein the first media signal occupies at least one first frequency channel of the combined signal and the second media signal occupies at least one second frequency channel of the combined signal different from the at least one first frequency channel; and
transmitting the combined signal to a video equipment at a user location.

2. The method of claim 1, further comprising:
identifying one or more empty frequency channels that are not occupied by the second media signal; and
wherein combining the first media signal and the second media signal comprises: inserting the first media signal into the one or more unused frequency channels.

3. The method of claim 1, further comprising:
receiving the combined signal;
identifying at least one media channel from the first media signal and a set of media channels from the second media signal;
identifying a set of channel numbers corresponding to the set of media channels from the second media signal;
identifying at least one unused channel number that is not in the set of channel numbers;
generating a channel guide user interface, wherein the channel guide interface comprises a reference for each of the set of channel numbers to the corresponding media channels from the set of media channels from the second media signal and a reference for the at least one unused channel number to the at least one media channel from the first media signal; and
transmitting the channel guide user interface to the video equipment.

4. The method of claim 1, wherein:
the first modulation scheme comprises an 8-level vestigial sideband modulation (8VSB) modulation scheme; and
the second modulation scheme comprises a quadrature amplitude modulation (QAM) or IP modulation scheme.

5. The method of claim 1, wherein:
the first media signal comprises an unencrypted media signal; and
the second media signal comprises an encrypted media signal.

6. The method of claim 1, wherein:
the first media signal and the second media signal each comprise digital video signals.

7. The method of claim 1, wherein:
the first media signal comprises an over-the-air broadcast signal.

8. The method of claim 1, wherein:
the second media signal comprises a cable television signal, a satellite television signal, a streaming media signal, or any combination thereof.

9. A non-transitory computer readable medium storing code for combining digital signals, the code comprising instructions executable by a processor to:
receive a first media signal at a user location, wherein the first media signal comprises a wireless radio transmission using a first modulation scheme;
receive a second media signal at the user location, wherein the second media signal is transmitted from a remote location using a second modulation scheme different from the first modulation scheme;
demodulate the first media signal according to the first modulation scheme;
modulate the demodulated first media signal according to the second modulation scheme;
combine, at the user location, the first media signal with a second media signal to generate a combined signal, wherein the second media signal is modulated according to the second modulation scheme, and wherein the first media signal occupies at least one first frequency channel of the combined signal and the second media signal occupies at least one second frequency channel of the combined signal different from the at least one first frequency channel; and
transmit the combined signal to a video equipment at a user location.

10. The non-transitory computer-readable medium of claim 9, wherein the code further comprises instructions executable by the processor to:
identify one or more empty frequency channels that are not occupied by the second media signal; and
combine the first media signal and the second media signal by: inserting the first media signal into the one or more unused frequency channels.

11. The non-transitory computer-readable medium of claim 9, wherein the code further comprises instructions executable by the processor to:
receive the combined signal;
identify at least one media channel from the first media signal and a set of media channels from the second media signal;
identify a set of channel numbers corresponding to the set of media channels from the second media signal;
identify at least one unused channel number that is not in the set of channel numbers;
generate a channel guide user interface, wherein the channel guide interface comprises a reference for each of the set of channel numbers to the corresponding media channels from the set of media channels from the second media signal and a reference for the at least one unused channel number to the at least one media channel from the first media signal; and
transmit the channel guide user interface to the video equipment.

12. The non-transitory computer-readable medium of claim 9, wherein:
the first modulation scheme comprises an 8VSB modulation scheme; and
the second modulation scheme comprises a QAM or IP modulation scheme.

13. The non-transitory computer-readable medium of claim 9, wherein:
the first media signal comprises an unencrypted media signal; and
the second media signal comprises an encrypted media signal.

14. The non-transitory computer-readable medium of claim 9, wherein:
the first media signal and the second media signal each comprise digital video signals.

15. The non-transitory computer-readable medium of claim 9, wherein:
the first media signal comprises an over-the-air broadcast signal.

16. The non-transitory computer-readable medium of claim 9, wherein:
the second media signal comprises a cable television signal, a satellite television signal, a streaming media signal, or any combination thereof.

17. An apparatus for combining digital signals, comprising:
a processor; and
a memory storing instructions and in electronic communication with the processor, the processor being configured to execute the instructions to:
receive a first media signal at a user location, wherein the first media signal comprises a wireless radio transmission using a first modulation scheme;
receive a second media signal at the user location, wherein the second media signal is transmitted from a remote location using a second modulation scheme different from the first modulation scheme;
demodulate the first media signal according to the first modulation scheme;
modulate the demodulated first media signal according to the second modulation scheme;
combine, at the user location, the first media signal with a second media signal to generate a combined signal, wherein the second media signal is modulated according to the second modulation scheme, and wherein the first media signal occupies at least one first frequency channel of the combined signal and the second media signal occupies at least one second frequency channel of the combined signal different from the at least one first frequency channel; and
transmit the combined signal to a video equipment at a user location.

18. The apparatus of claim 17, wherein the processor is further configured to execute the instructions to:
identify one or more empty frequency channels that are not occupied by the second media signal; and
combine the first media signal and the second media signal by: inserting the first media signal into the one or more unused frequency channels.

19. The apparatus of claim 17, wherein the processor is further configured to execute the instructions to:
receive the combined signal;
identify at least one media channel from the first media signal and a set of media channels from the second media signal;
identify a set of channel numbers corresponding to the set of media channels from the second media signal;
identify at least one unused channel number that is not in the set of channel numbers;
generate a channel guide user interface, wherein the channel guide interface comprises a reference for each of the set of channel numbers to the corresponding media channels from the set of media channels from the second media signal and a reference for the at least one unused channel number to the at least one media channel from the first media signal; and
transmit the channel guide user interface to the video equipment.

20. The apparatus of claim 17, wherein:
the first modulation scheme comprises an 8VSB modulation scheme; and
the second modulation scheme comprises a QAM or IP modulation scheme.
